(19) United States
(12) Patent Application Publication
(10) Pub. No.: US 2008/0006249 A1
(43) Pub. Date: Jan. 10, 2008

(54) Electronic pre-combustion treatment device

(76) Inventor: Erano Martin Evangelista, Las Pinas City (PH)

Correspondence Address: JOSE M CRUZ;ERANO M EVANGELISTA, P O BOX 842191, HOUSTON, TX, 77284-2191, US

(21) Appl. No.: 11/530,468

(22) Filed: Sep. 10, 2006

(30) Foreign Application Priority Data
Jul. 10, 2006 (MY) PI 20063262

(51) Int. Cl. F02B 51/00

(52) U.S. Cl. 123/536

(57) ABSTRACT

A device and method designed to use mini electrical storms to produce nitrogen oxide from air in an intake system to be mixed with a combustible fluid in the combustion chamber of an internal combustion engine. The device is designed to treat the air to produce nitrogen oxide to be mixed to the combustible fluid in an internal combustion system in order to enhance the efficiency of internal combustion. The device through the reactor generates mini electrical storm to produce nitrogen oxide from air to mix with the combustible fluid in the combustion chamber to enhance the efficiency of an internal combustion engine and further reduce exhaust emissions. The device is housed in a casing having an electrical wire that is designed to carry the mini electrical storm charges to a ring assembly to disassociate nitrogen and oxygen from air and produce nitrogen oxide in an air intake rubber hose in a vehicle's air intake system to mix with a liquid combustible fluid prior to combustion. The device includes wirings to receive power from the electrical system of the vehicle.

### BACKGROUND OF THE INVENTION

1. The Technical Field

The present invention relates to fuel pre-combustion treatment devices that can be used in internal combustion systems as a way to efficiently burn fuel in a combustion chamber. More particularly, the present invention relates to a design of a reactor that generates mini electrical storm to produce nitrogen oxide from air and to be used as a fuel additive to be entrained in the air/fuel stream. Still more particularly, the present invention relates to an electronic fuel pre-combustion device that disassociates nitrogen and oxygen from air to produce nitrogen oxide by way of exposing said air to mini electrical storms generated by a reactor and said nitrogen oxide to be combined with a liquid combustible fuel so that said liquid combustible fuel burns more efficiently in a combustion chamber, with reduced exhaust emissions, increase in engine performance and power-to-weight ratio, and improvement in fuel economy.

2. Description of the Prior Art

Hydrocarbon fuel combustion is one of the most widely used energy sources in the world. The environmental hazards associated with hydrocarbon fuel combustion emissions are well known, and accordingly many treatment methods have been developed to reduce harmful pollutants during the combustion of hydrocarbons.

For example, fuel additives have been formulated for the pre-combustion treatment of specific fuels. However, such additives are consumable and must therefore be added on a regular basis. The production of fuel additives consumes finite resources and it contributes to environmental problems. Further, each type of fuel requires its own specially formulated additive, which must be combined with the fuel in precise proportions and is therefore not well suited for consumer use.

Also, another device called a turbocharger, a type of forced induction system, which compresses the air flowing into the engine. The advantage of compressing the air is that it lets the engine squeeze more air into a cylinder, and more air means that more fuel can be added, and as a result more power is gained from each explosion in each cylinder. A turbocharged engine produces more power overall than the same engine without the charging. This can significantly improve the power-to-weight ratio for the engine in order to achieve this boost. The turbocharger uses the exhaust flow from the engine to spin a turbine, which in turn spins an air pump.

Turbochargers allow an engine to burn more fuel and air by packing more into the existing cylinders. The typical boost provided by a turbocharger is 6 to 8 pounds per square inch (psi). Since normal atmospheric pressure is 14.7 psi at sea level, meaning that there is an additional 50 percent of air that is introduced into the engine. Therefore, it is expected to get 50 percent more power. It is not perfectly efficient, so you might get a lower percentage in engine improvement.

One cause of the inefficiency comes from the fact that the power to spin the turbine is not free. Having a turbine in the exhaust flow increases the restriction in the exhaust. This means that on the exhaust stroke, the engine has to push against a higher back-pressure. This subtracts a little bit of power from the cylinders that are firing at the same time.

Though a turbocharger can be a simpler, more compact way to add power, sometimes it may not be feasible—since modification to the engine would be needed to accommodate the turbocharger device and there is significant wear and tear to the engine and it parts.

Post-combustion treatment devices such as catalytic converters and fuel gas scrubbers have also been developed to reduce harmful combustion emissions. However, these types of devices are fuel-specific and must be properly installed and maintained in order to have a practical life span, which is in any event limited. Moreover, such post-combustion treatment devices do not address the efficiency of fuel combustion, and therefore do not aid in preserving non-renewable fuel resources.

Therefore, what is needed is a device and method that will enhance fuel combustion, increase the power-to-weight ratio, and further reduce exhaust emissions, optimize engine performance, improve fuel economy and recycle polluted air as a fuel additive in an internal combustion system. In particular, what is needed is a device that will utilize the air that is in use in an internal combustion system which will provide a limitless amount of nitrogen oxide produced by exposure of said air to mini electrical storms and combine with a liquid combustible fuel to enhance combustion of an internal combustion system. More particularly, what is needed is a device and method that will not require significant modification or alteration to an internal combustion engine.

The present invention uses a more efficient and environmentally acceptable method of increasing the efficiency of the combustion process in an internal combustion system. The present invention generates mini electrical storm that simulates the creation of a lightning bolt on a minute scale that when air is exposed to said mini electrical storms nitrogen and oxygen are disassociated from said air and transformed into nitrogen oxide. Nitrogen, normally a relatively inert gas, readily reacts with oxygen when there is a source of energy to produce a high temperature. The present invention achieves this process by creating mini electrical storms to produce said nitrogen oxide from air as a pre-combustion fuel additive.

The rationale for the present invention is of the formation and production of nitrogen oxide whenever combustion of fuels occurs. The formation of nitrogen oxide requires heat; it follows that a higher combustion temperature would produce relatively more nitrogen oxide. The combustion of gasoline vapors in an automobile engine is always accompanied by the production of nitrogen oxide because both nitrogen and oxygen are present in the combustion chamber. But this occurs during the post-combustion stage which results to nitrogen oxide emission which pollutes the air. High concentration of emissions are the result of improper combustion of hydrocarbon fuels, what is needed is a method of collecting the accumulated pollutants present in the air to be reintroduced and efficiently burned again in an internal combustion engine.

When nitrogen oxide is heated to about 570 degrees F (˜300 C), it splits into oxygen and nitrogen. So the injection of nitrogen oxide into an engine means that more oxygen is available during combustion producing more power. It is one of the simplest ways to provide a significant horsepower boost to any internal combustion engine.

Nitrogen oxide has another effect that improves performance even more. When it vaporizes, nitrous oxide provides a significant cooling effect on the intake air, which would replace the cooling device fitted in engines mounted with turbochargers. When you reduce the intake air temperature, you increase the air's density, and this provides even more oxygen inside the cylinder.

The only problem with nitrogen oxide is that it is fairly bulky, and the engine needs a lot of it. Like any gas, it takes up a fair amount of space even when compressed into a liquid. A 5-liter engine running at 4,000 rotations per minute (rpm) consumes about 10,000 liters of air every minute (compared to about 0.2 liters of gasoline), so it would take a tremendous amount of nitrous oxide to run a car continuously. Therefore, a car normally carries only a few minutes of nitrous oxide, and the driver uses it very selectively by pushing a button.

The present invention overcomes this problem by providing a limitless amount of nitrogen oxide produced from the air passing at the pre-combustion stage in the air intake system of a vehicle.

### SUMMARY OF THE INVENTION

Accordingly, it is the primary object of the present invention to provide a device for converting air into nitrogen oxide as a pre-combustion fuel enhancement produce before entering the combustion chamber of an internal combustion engine;

Also, it is the object of the present invention to provide a device that utilizes the air present in the environment and treat it by way of exposure to mini electrical storms to produce nitrogen oxide as pre-combustion fuel enhancement produce thereby minimizing emissions and reducing pollutants in the air.

It is another object of the present invention to provide a device for converting air to nitrogen oxide before entering the combustion chamber of an internal combustion engine that is simple in design and construction so that cost of acquiring and running and maintaining are minimized.

It is yet another object of the present invention to provide a device for converting air to nitrogen oxide before entering the combustion chamber of an internal combustion engine that is facile to install and uninstall.

These and other objects of the present invention are achieved by;

A device for producing nitrogen dioxide from air to be combined with a combustible fluid to enhance combustion within a combustion chamber of an internal engine, said device comprising:

a reactor for generating mini electrical storms,

a housing where the said reactor is encased;

an air treating means; and

an electrical wiring carrying electrical charges from said reactor to said air treating means;

said air treating means being a ring assembly whereby air passing through said ring assembly inside an air intake rubber hose is subjected to mini electrical storms producing nitrogen oxide to thereby mixed with a combustible fluid and subsequently burned in said combustion chamber.

### BRIEF DESCRIPTION OF THE DRAWINGS

FIG. 1 shows a simplified drawing of the preferred embodiment of the present invention.

FIG. 2 shows a simplified diagrammatic representation of the delivery of the created nitrogen oxide to the air intake and carburetor of an internal combustion engine.

FIG. 3 shows a front view of the ring assembly of the present invention.

### DETAILED DESCRIPTION OF THE PREFERRED EMBODIMENT

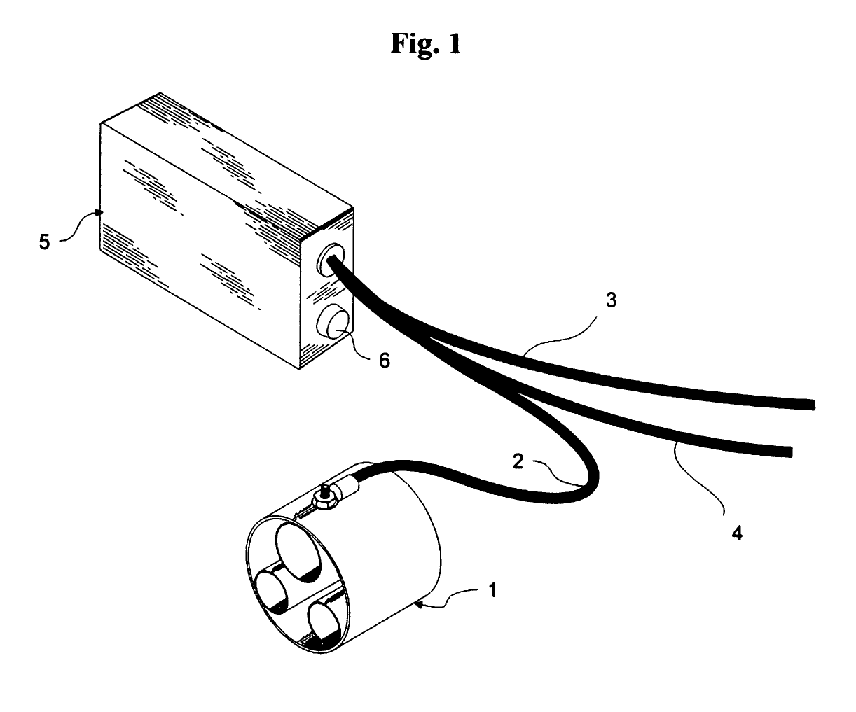

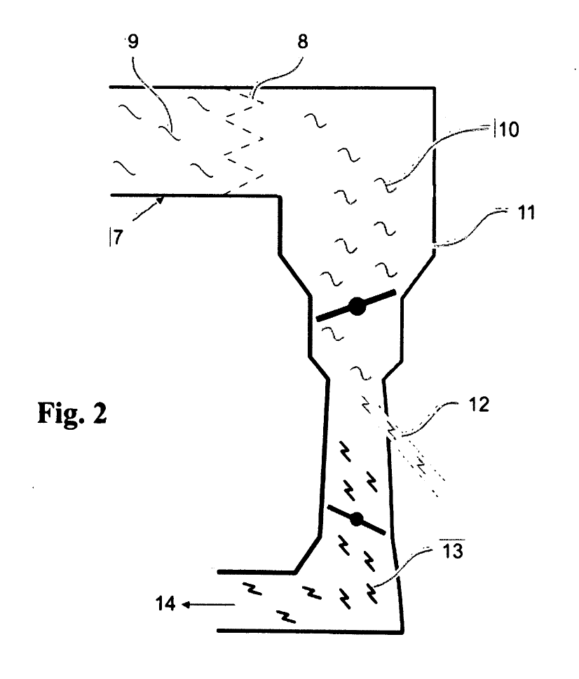

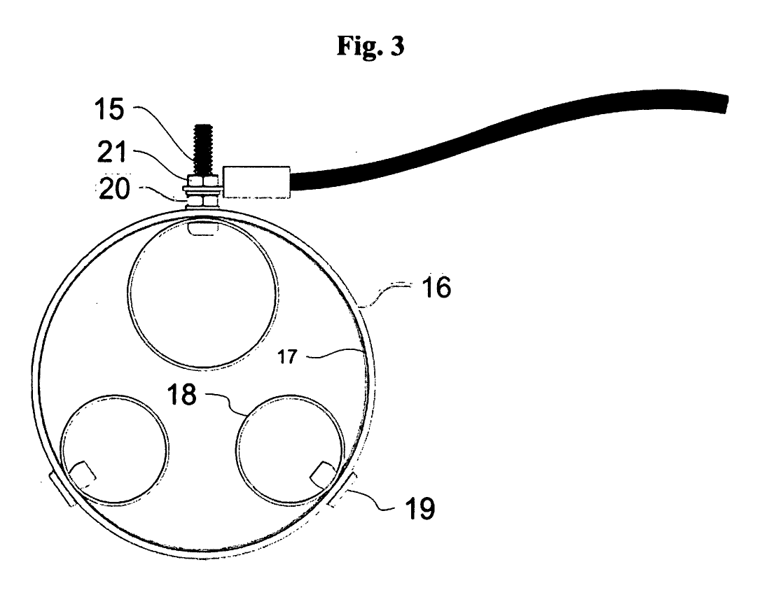

The general operation of the preferred embodiment of the present invention is illustrated in FIGS. 1, 2 and 3 by a reactor 1, an electrical wire 2 that carries the mini electrical storm charge 8 to a ring assembly 5, an electrical wire 3 that connects to the ignition line, and another electrical wire 4 that connects to the ground of an electrical system of an automobile, an indicator light 6. The objective of the reactor 1 is to generate mini electrical storm 8 to disassociate nitrogen and oxygen from air 9 to produce nitrogen oxide 10. The process of disassociation takes place in the ring assembly 5 which is installed in an air intake rubber hose 7. Nitrogen oxide 10 is then combined with a combustible fluid 12 to form a rich mixture of combustible fuel for burning in an internal combustion system.

In an air intake system of an automobile, for example, the ring assembly 5 is installed inside an air intake rubber hose 7 used to deliver air 9 to an intake manifold 14 that is a standard component of an internal combustion system of said automobile (not shown). The reactor 1 can be mounted anywhere inside the passenger cabin of an automobile (not shown) and the power required to enable the said reactor 1 is drawn from the electrical system of the said automobile.

The reactor 1 generates mini electrical storm that is likened to a lightning bolt but on a minute scale. The reactor is facilely operated using a 12-Volt automobile battery.

The ring assembly 5 is installed inside an air intake rubber hose 7, a hole is drilled on one end of the said air intake rubber hose 7 that is near the air intake before the carburetor (not shown) to hold the said ring assembly 5 by inserting a screw 15 from the inside protruding outward, and by fastening the said ring assembly firmly in place locking the said screw 15 with a washer 22 and a nut 21. The ring assembly 5 comprises an outer ring 17 that is made of a non-conductive material and a set of inner rings 19, called sparking rings, composed of a thin sheet of conductive material 18 lined to the inside part of the outer ring 17 and three small rings 19 that are made of conductive material that are equally distributed in the inside periphery of the outer ring 17 and a thin sheet of conductive material 18, and said smaller rings are fastened by rivets 20.

The objective of the additional smaller rings 20 is to cover the whole area that is inside the outer ring 17 to subject the passing air 9 to mini electrical storms 8 and thereby mix with the combustible fluid 12 in the form of a fuel-nitrogen oxide fluid 13 to be delivered to the intake manifold 14 of an internal combustion system.

I claim:

1. A device for producing nitrogen dioxide from air to be combined with a combustible fluid to enhance combustion within a combustion chamber of an internal combustion engine, said device comprising:
a. a reactor for generating mini electrical storms,
b. a housing where the said reactor is encased;
c. an air treating means; and
d. an electrical wiring carrying electrical charges from said reactor to said air treating means;
e. said air treating means being a ring assembly whereby air passing through said ring assembly that is installed inside an air intake rubber hose is subjected mini electrical storms generated by said reactor thereby producing nitrogen oxide to mix with a combustible fluid and subsequently burned in said combustion chamber of an internal combustion engine.

2. A device as claimed in claim 1, further characterized by said ring assembly having at least two sections, a main ring (6) and a set of sparking rings.

3. A device as claimed in claim 2, further characterized by said ring assembly comprises an outer ring and a set of inner rings.

4. A device as claimed in claim 3, further characterized by said outer ring being made from a non-conductive material.

5. A device as claimed in claim 4, further characterized by said non-conductive material being plastic.

6. A device as claimed in claim 3, further characterized by said set of inner rings being made from a conductive material.

7. A device as claimed in claim 6, further characterized by conductive material being made from copper or aluminum.

8. A method of producing nitrogen oxide from air to be combined with a combustible fluid for combustion for combustion, said method comprising the steps of:
a. exposing said air to mini electrical storms generated by a reactor, by disassociating nitrogen and oxygen from the said air to produce nitrogen oxide as a fuel additive
b. combining said nitrogen oxide and said combustible fluid together for combustion in said combustion chamber.
